(19) United States
(12) Patent Application Publication
(10) Pub. No.: US 2023/0143324 A1
(43) Pub. Date: May 11, 2023

(54) System And Method for Determining Cleaning Schedules For Heat Exchangers And Fired Heaters Based On Engineering First Principles And Statistical Modelling

(71) Applicant: Suncor Energy Inc., Calgary (CA)

(72) Inventors: Waldo COETZEE, Calgary (CA); Gisèle Chung Mouy TONG, Calgary (CA); Yashar FARAJOLLAHI, Calgary (CA)

(73) Assignee: Suncor Energy Inc., Calgary (CA)

(21) Appl. No.: 17/938,519

(22) Filed: Oct. 6, 2022

(30) Foreign Application Priority Data
Nov. 10, 2021 (CA) 3138441

(51) Int. Cl. G05B 23/02; G06Q 10/06

(52) U.S. Cl. CPC G05B 23/0283; G06Q 10/06311; G05B 23/0243

(57) ABSTRACT

A system and method are provided for determining cleaning schedules for equipment. The equipment includes fired heaters and/or heat exchangers. The method includes obtaining historical sensor data; transforming the obtained sensor data using an engineering first principles process; applying data analytics to the transformed data to generate at least one statistical model; predicting an indicator of fouling in the equipment using operating data and the at least one statistical model; obtaining cost data associated with the equipment being analyzed; determining from the prediction and cost data a desired cleaning schedule for the equipment; and providing an output associated with the desired cleaning schedule.

### CROSS-REFERENCE TO RELATED APPLICATION(S)

This application claims priority to Canadian Patent Application No. 3,138,441 filed on Nov. 10, 2021, the contents of which are hereby incorporated by reference in their entirety.

### TECHNICAL FIELD

The following relates to systems and methods for determining cleaning schedules for heat exchangers and fired heaters, based on engineering first principles and statistical modelling.

### BACKGROUND

Various industrial processes use heat exchangers to transfer heat between two or more fluids using the temperature difference between the fluids as the driving force. Fired heater(s) can be defined as direct-fired heat exchanger(s) that transfer(s) heat from hot combustion gasses (e.g., flue gasses typically produced by combusting fuel gas) to a process fluid flowing through the coils arranged inside the heater. Examples include heating or pre-heating crude oil in a refinery, generating steam for manufacturing and advance oil recovery processes such as steam assisted gravity drainage (SAGD), transferring heat between various processes as part of process utilities, or in other oil extraction techniques, to name a few.

In crude units at petrochemical refineries, crude oil is heated to a specific temperature range to ensure efficient separation in downstream distillation column(s) (e.g., atmospheric and vacuum distillation columns). This is achieved through a combination of heat exchangers and fired heaters. Typically, the fired heater(s) will maintain (or control) the outlet temperature of the pre-heat train and compensate for the reduced heat transfer efficiency of the heat exchangers that occurs because of fouling deposition over time. This is done by increasing the firing duty of the fired heater(s) and can come at the cost of increased fuel gas consumption and greenhouse gas emissions. When the fired heater(s) reach(es) its/their maximum capacity and can no longer compensate for further heat transfer deterioration due to heat exchanger fouling, production should be lowered such that the final outlet temperature can be maintained. Lowering production such as that described above can have significant economic implications, as it can directly impact refinery productivity and utilization.

With fired heaters or other fired apparatus, such as crude heaters, fired heater reboilers, once through steam generators (OTSGs), etc., tube fouling (or coking) can be a problem that occurs due to the accumulation and formation of unwanted materials on the surfaces of the tubing in the fired apparatus. This accumulation typically occurs due to impurities in the fluid feed in combination with other operational and design parameters. As such, the accumulation (or fouling) rate can be dependent on, among other things, the feed composition (and quality), operating temperature, flowrates, and design of the heater (e.g., burner type and location). Fouling of fired heater tubes has the effect of reducing efficiency by requiring more fuel gas to transfer the same amount of heat (energy) into the process fluid. This in turn results in higher tube metal temperatures that may increase over time as the fouling deposition increases. At some point this temperature can exceed the safe operating limit specified for the material (tube metal) and could result in a mechanical failure of the tube(s). Some operating parameters (such as feed flowrate, combustion air flowrate, etc.) can be manipulated to manage tube metal temperatures. Amongst other parameters, production rate can be lowered to maintain tube metal temperatures below the safe operating limit until the prescheduled cleaning (or pigging) time arrives; however, lowering production can again have significant economic implications.

There exist various approaches to monitoring tube fouling by measuring parameters such as tube skin temperature, pressure drop across the tube, and stack temperature and safety systems that will act to prevent failures and/or incidents. However, these solutions tend to focus on the current state of the tube fouling, which provides only a limited view of that current state. Predicting in advance when the shutdown and cleaning (or pigging) of the tubes need to occur could improve the ability to better plan downtime and manage risk.

Heat exchangers are used in many applications to transfer heat between two or more fluids, in either or both cooling and heating processes. For example, heat exchangers are often used to pre-heat fluids that are heated in fired apparatus such as those discussed above. Heat exchangers can include internal wall(s) to separate the fluids and prevent mixing. There are several industrial applications in which heat exchangers can be used, for example in oil and gas processes such as in crude pre-heat trains, or boiler feed water pre-heat networks. Heat exchangers are often used in conjunction with fired heaters, e.g., to pre-heat crude fed to a crude heater.

Cleaning a fired heater or a heat exchanger involves taking the equipment offline and applying a cleaning process. For fired heaters this typically involves pigging the tubes while for heat exchangers this can involve hydroblasting, among other methods. Typically, heat exchangers are monitored to determine if they are becoming less efficient due to, among other parameters, a decrease in the overall heat transfer coefficient (OHTC), indicating that cleaning may need to be considered. Many cleanings need to be scheduled to occur during a shutdown (or turnaround) and need to be scheduled well in advance to allow for allocation of necessary time and resources to minimize overall downtime. Monitoring heat exchanger performance can be inaccurate and often involves using limited available data at that time while being expected to make predictions several months into the future. This makes it challenging to schedule cleanings in advance as required by the respective maintenance planning teams. In addition, economic calculations need to be performed to determine whether cleaning at the proposed dates would be beneficial and prioritize what equipment would benefit the most from cleaning.

### SUMMARY

The presently described system provides an accurate projection into the future beyond a few weeks or months to enable planning an end of run for fired heaters, on a longer horizon. This can be done by obtaining historical sensor data from instrumentation in the apparatus/network/process/system, transforming or pre-processing the sensor data (this may include calculating engineering metrics such as process duty and cumulative impurities and/or other fouling correlated properties) and applying statistical models (e.g., advanced analytics such as machine learning) to predict tube skin temperature, which predicts when upper temperature limit will be exceeded (the end of run of the fired heater) when it needs to be cleaned (e.g., using a pigging process) or replaced (including tube replacement).

The present system can also be used to enhance the scheduling using actual performance of, and data obtained from, the heat exchanger. The presently described system is also configured to determine optimized cleaning schedules for heat exchangers by using, among other variables, cumulative flow as an indication of utilization and, consequently, calculating future heat duty based on a predicted OHTC. This is then used in calculating a cost curve to determine an economic optimum or proposed/deferred cleaning cost based on a predicted OHTC by projecting into the future beyond current operating conditions.

In one aspect, there is provided a method of determining cleaning schedules for equipment comprising fired heaters and/or heat exchangers, comprising: obtaining historical sensor data; transforming the obtained sensor data using an engineering first principles process; applying data analytics to the transformed data to generate at least one statistical model; predicting an indicator of fouling in the equipment using operating data and the at least one statistical model; obtaining cost data associated with the equipment being analyzed; determining from the prediction and cost data a desired cleaning schedule for the equipment; and providing an output associated with the desired cleaning schedule.

In another aspect, there is provided a computer readable medium comprising computer executable instructions that when executed by a processor of a computing device cause the process to perform the above method.

In another aspect, there is provided a system for determining cleaning schedules for equipment comprising fired heaters and/or heat exchangers, the system comprising a processor and memory, the memory storing computer executable instructions that, when executed by the processor, cause the system to: obtain historical sensor data; transform the obtained sensor data using an engineering first principles process; apply data analytics to the transformed data to generate at least one statistical model; predict an indicator of fouling in the equipment using operating data and the at least one statistical model; obtain cost data associated with the equipment being analyzed; determine from the prediction and cost data a desired cleaning schedule for the equipment; and provide an output associated with the desired cleaning schedule.

In an implementation, the desired cleaning schedule can be determined as an economic optimum by comparing an optimum cleaning time to at least one external factor. The at least one external factor can include scheduled shut down or maintenance events for the equipment, the desired cleaning schedule being determined according to a comparison of costs associated with running the equipment past the optimum cleaning time with costs associated with adding a shut down event to accommodate the desired cleaning.

In an implementation, the desired cleaning schedule can be selected as the optimum cleaning time.

In an implementation, the equipment can include at least one heat exchanger and wherein determining the desired cleaning schedule comprises predicting an overall heat transfer coefficient as the indicator of fouling, calculating a duty value of the heat exchanger, and calculating a cost curve associated with operating the heat exchanger. The duty value can be a cumulative value. The duty value can also be cumulative flow. The duty value can include cumulative impurities.

In an implementation, the equipment can include at least one fired heater and wherein determining the optimum cleaning schedule comprises predicting a tube skin temperature as the indicator of fouling, predicting an end-of-run for the fired heater based on the predicted tube skin temperature, and calculating cumulative production at the end of run date to calculate a cost curve.

In an implementation, the equipment can include a heat exchanger train comprising a plurality of heat exchangers and a fired heater.

In an implementation, the data analytics can include applying at least one machine learning technique to train the at least one statistical model. The method can further include re-training the at least one statistical model using data accumulated since the model was previously trained. At least one first statistical model can be trained for heat exchangers, and/or at least one second statistical model can be trained for fired heaters.

In an implementation, the method can further include determining at least one cleaning detection variable; transforming the at least one cleaning detection variable to a ratio of forward and backwards moving averages of the respective variable; setting a number of points representing a number of days used in the respective moving average; determining whether the transformed ratio exceeds a specified threshold, the threshold being adjustable based on at least one sensitivity requirement; selecting a local maximum within a cluster of the points; and using the local maximum in determining the desired cleaning schedule.

In an implementation, the desired cleaning schedule can be determined by comparing the local maximum to a fouled state.

In an implementation, the method can further include identifying cycles of the equipment; fitting a combination of historical cycles; and using a weighting strategy to apply a higher weight to more recent cycles than older cycles to prioritize fitting more recent data.

In an implementation, the method can further include enabling a manual override of a cleaning date when a cycle detection fails.

In an implementation, the method can include determining an annualized fouling cost from an overall heat transfer coefficient as the indicator of fouling, by: determining a heat duty based on mass and energy balances using a predicted overall heat transfer coefficient, inlet hot and cold side temperatures, respective inlet hot and cold side flowrates, and at least one additional physical property; and adding respective fouling costs based on fuel gas required to compensate for decreasing duty, annualized maintenance cost based on historic cost data, and emission-related costs based on a release rate of the fuel gas. A tradeoff in the desired cleaning schedule can be determined between decreasing annualized maintenance cost and fouling and emission-related costs, wherein a minimum is selected as an optimum cleaning time. The method can also include displaying a cost curve with at least two cleaning dates on the curve to permit an assessment thereof.

In an implementation, the method can further include coupling a fired heater cost curve with a tube skin temperature curve to calculate a cost per year against a fouling cycle; normalizing costs with respect to time; and predicting an end of run for at least one cleaning opportunity. The end of run can be predicted for a plurality of cleaning opportunities and the method further comprises enabling a comparison and a selection to be made between the plurality of cleaning opportunities.

In an implementation, the output can include a graphical user interface dashboard. The dashboard can provide a tube skin temperature prediction graph to enable a user to predict when a safe operating limit will be reached for each tube skin temperature measurement in the equipment. The dashboard can provide a visual depiction of tube skin temperature to permit a user to observe heat distribution in a fired heater and diagnose possible problems. The possible problems can include one or more of burner damage, plugging or misalignment.

In an implementation, the dashboard can provide a heat exchanger cost curve. The heat exchanger cost curve can be interacted with such that different inputs to the cost data are adjustable to visualize an impact on the cost curve. Proposed and deferred cleaning dates can be selectable and the dashboard displays a corresponding cleaning benefit.

In an implementation, the output can include control instructions for operating the equipment.

In an implementation, the output can include a report.

In an implementation, the method can include continually collecting raw field data.

In an implementation, a fouling status can be compared to a clean state for the equipment. The method can include ranking one or more heat exchangers per fouling status to determine which heat exchanger would benefit most from a cleaning process. The method can include ranking one or more fired heaters or passes of a single fired heater, to determine which tube skin temperature is most limiting. The rankings can be provided using a table depicting at which date each pass of the fired heater can be independently cleaned.

In another aspect, there is provided a method of detecting cleaning schedules for equipment comprising fired heaters and/or heat exchangers, comprising: determining at least one cleaning detection variable; transforming the at least one cleaning detection variable to a ratio of forward and backwards moving averages of the respective variable; setting a number of points representing a number of days used in the respective moving average; determining whether the transformed ratio exceeds a specified threshold, the threshold being adjustable based on at least one sensitivity requirement; selecting a local maximum within a cluster of the points; and using the local maximum in determining the desired cleaning schedule.

In another aspect, there is provided a computer readable medium comprising computer executable instructions that when executed by a processor of a computing device cause the process to perform the above method.

In another aspect, there is provided a system for detecting cleaning schedules for equipment comprising fired heaters and/or heat exchangers, the system comprising a processor and memory, the memory storing computer executable instructions that, when executed by the processor, cause the system to: determine at least one cleaning detection variable; transform the at least one cleaning detection variable to a ratio of forward and backwards moving averages of the respective variable; set a number of points representing a number of days used in the respective moving average; determine whether the transformed ratio exceeds a specified threshold, the threshold being adjustable based on at least one sensitivity requirement; select a local maximum within a cluster of the points; and use the local maximum in determining the desired cleaning schedule.

In an implementation, the desired cleaning schedule can be determined by comparing the local maximum to a fouled state.

In an implementation, the method can include identifying cycles of the equipment; fitting a combination of historical cycles; and using a weighting strategy to apply a higher weight to more recent cycles than older cycles to prioritize fitting more recent data.

In an implementation, the method can include enabling a manual override of a cleaning date when a cycle detection fails.

Advantages of the system include the ability to accurately project into the future and plan for end of run for fired heaters and cleaning scheduling for both fired heaters and heat exchangers. There may be other factors, e.g., maintenance opportunities that could prevent heat exchangers to be cleaned at the mathematical optimum cleaning dates. The approach described herein provides the ability to assess the economic implications when comparing different cleaning dates e.g., different maintenance event opportunities, fuel gas cost, fuel gas composition, emissions taxes, etc.

### BRIEF DESCRIPTION OF THE DRAWINGS

Embodiments will now be described with reference to the appended drawings wherein:

FIG. 1 is a schematic diagram of a heat exchanger and fired apparatus monitoring and analysis system.

FIG. 2 is a schematic diagram of fired heater fed by a network of heat exchangers for conceptual purposes.

FIG. 3 is a schematic diagram of a fired heater typically used in a refinery.

FIG. 4 is a schematic diagram of a typical shell and tube heat exchanger.

FIG. 5 is a schematic diagram showing details of an OTSG-type fired heater and heat exchanger pre-heat train.

FIG. 6 is a flow chart illustrating a data modeling pipeline.

FIG. 7a is a schematic block diagram of a data analytics engine used in the system shown in FIG. 1.

FIG. 7b is a schematic block diagram of an advanced analytics platform providing an alternative configuration for the data analytics engine used in the system shown in FIG. 1.

FIG. 8a is a flow chart illustrating a process for determining a cleaning schedule for a fired heater.

FIG. 8b is a flow chart illustrating a process for determining a cleaning schedule for a heat exchanger.

FIG. 9a is an example of a fouling cost curve for heat exchangers.

FIG. 9b is an example of a fouling cost curve for fired heaters showing economic evaluation of cycles with different run length (e.g. point A vs. point B).

FIGS. 10a, 10b, 10c, and 10d illustrate a cleaning detection using a data transformation.

FIGS. 11a, 11b, and 11c illustrate an annualized fouling cost computed from an OHTC prediction (U) and a heat duty (Q) calculation.

FIGS. 12a and 12b show a tube skin temperature prediction graph provided in a graphical user interface.

FIGS. 12c and 12d show a heat exchanger cost curve using an interactive graphical user interface.

FIGS. 13a, 13b, and 13c together are a spatial depiction of a tube skin monitoring system showing a thermocouples map in a fired heater, provided in a graphical user interface.

FIG. 14 is a flow chart illustrating operations performed in determining cleaning schedules for equipment comprising fired heaters and/or heat exchangers.

FIG. 15 is a plot showing the impact of the cycle weighting strategy for different choices in the weight exponent term.

### DETAILED DESCRIPTION

A system is provided that uses historical data, statistical modelling, and predictions, to estimate an end of run for a fired heater and to determine economically optimum or otherwise desired cleaning schedules for heat exchangers, fired heaters, and heat exchanger networks.

Due to the aforementioned fouling, fired heaters have a cycle period or “run” at which point the fired heater is taken offline for the tubes to be cleaned (pigged) or be repaired/replaced if necessary. In a fired apparatus, there is a risk of damaging the equipment if you go beyond a certain tube skin temperature. That is, the tube skin temperature can be considered a hard limit or upper threshold and, as such, one should manage the run length so that the fired heater is taken offline before hitting that hard limit. With the ability to predict the end of run, engineers can also determine whether it is possible to extend the time for the run and can thus devise an outage plan and maintenance plan with that in mind, e.g., by changing operating parameters to push out the end of run or clean earlier where that cleaning is aligned with other maintenance events possibly with the benefit of increasing production due to the shorter run length. This can allow maintenance costs and schedules to be more efficiently managed. Since potential production loss (and/or downtime due to cleaning and cleaning costs) can be estimated, economic factors (or economic optimum) can be calculated without being constrained by exceeding the safe operating limit of the equipment.

While a fouling factor (or fouling resistance) or OHTC that is used by way of example herein for predicting end of run for fired heaters is based on predicting tube skin temperatures, the principles described below can be adapted to predict other fouling indicators, for instance, a pressure drop across the tubing, or stack temperature in fired heater. Similarly, while examples described herein may be presented in the context of a crude heater or steam generating apparatus, the principles described herein can also be applied to other types of fired apparatus used to heat any fluid that has a fouling potential such as fired heaters for general refinery service.

Engineers are typically required to plan for shut down scenarios months in advance, whether or not the fired heater needs to be cleaned or repaired (including tube replacement). The presently described system provides an accurate projection into the future beyond a few weeks or months to enable planning an end of run for fired heaters, on a longer horizon. This can be done by obtaining historical sensor data from instrumentation in the apparatus/network/process/system, transforming or pre-processing the sensor data (this may include calculating engineering metrics such as process duty and cumulative impurities and/or other fouling correlated properties) and applying statistical models (e.g., advanced analytics such as machine learning) to predict tube skin temperature, which predicts when upper temperature limit will be exceeded (the end of run of the fired heater) when it needs to be cleaned (e.g., using a pigging process) or replaced (including tube replacement). Economic factors or other considerations (maintenance opportunity) could mean that the actual cleaning date may be earlier than the date of temperature limit exceedance. The cost of cleaning could be balanced by the cost of production loss (for example, reducing the flowrate to extend the run) or the cost of feeding higher quality feed material (if possible). The system can also be configured to initiate, trigger or otherwise provide a prompt to perform the actual cleaning according to a determined/desired schedule.

For heat exchangers, using an optimum cleaning schedule has economic benefits by balancing the cleaning costs with inefficiencies introduced by fouling. That is, one can go beyond a particular cleaning schedule, but there is a tradeoff between energy/emissions costs and maintenance costs. Conversely, the heat exchanger may be cleaned at an earlier date than a particular cleaning schedule to improve energy efficiency. Varying cost of fuel gas, fuel gas composition, emissions taxes (e.g. CO₂ tax) etc. can influence the economic evaluation. The present system can be used to enhance the scheduling using actual performance of, and data obtained from, the heat exchanger. The presently described system is also configured to determine optimized cleaning schedules for heat exchangers by using, among other variables, cumulative flow as an indication of utilization and, consequently, calculating future heat duty based on a predicted OHTC. This is then used in calculating a cost curve to determine an economic optimum or proposed/deferred cleaning cost based on a predicted OHTC by projecting into the future beyond current operating conditions. This can be done by obtaining historical sensor data, pre-processing the historical data, determining OHTC using engineering principles (may be executed using process simulation software), applying advanced analytics such as machine learning to predict the OHTC values and duty into the future, determining a cost curve, and determining a desired (e.g., optimum) economic cleaning schedule. As with fired heaters, the system can also be configured to initiate, trigger or otherwise provide a prompt to perform the actual cleaning according to a determined/desired schedule.

There may be other factors, e.g., maintenance opportunities that could prevent heat exchangers to be cleaned at the mathematical optimum cleaning dates. This approach provides the ability to assess the economic implications when comparing different cleaning dates e.g., different maintenance event opportunities, fuel gas cost, fuel gas composition, emissions taxes. Typically, the economic benefits from cleaning should be compared to others in the unit as there may be a constraint as to how many heat exchangers may be cleaned during a given maintenance event. This approach enables a quantitative methodology to select the best cleaning candidates for a given maintenance event. In some cases, where a heat exchanger has already been significantly fouled, a heat exchanger may not be expected to experience significant further deterioration in heat transfer performance (e.g., little further degradation in OHTC) due to the physical nature of the fouling phenomenon (e.g., nearing an asymptotic limit). In such cases, it can be useful to compare the expected duty gain after cleaning against other heat exchangers in the unit. This has the benefit of showing immediate duty gain that can be obtained and can be useful in identifying severely fouled heat exchangers nearing asymptotic fouling limits.

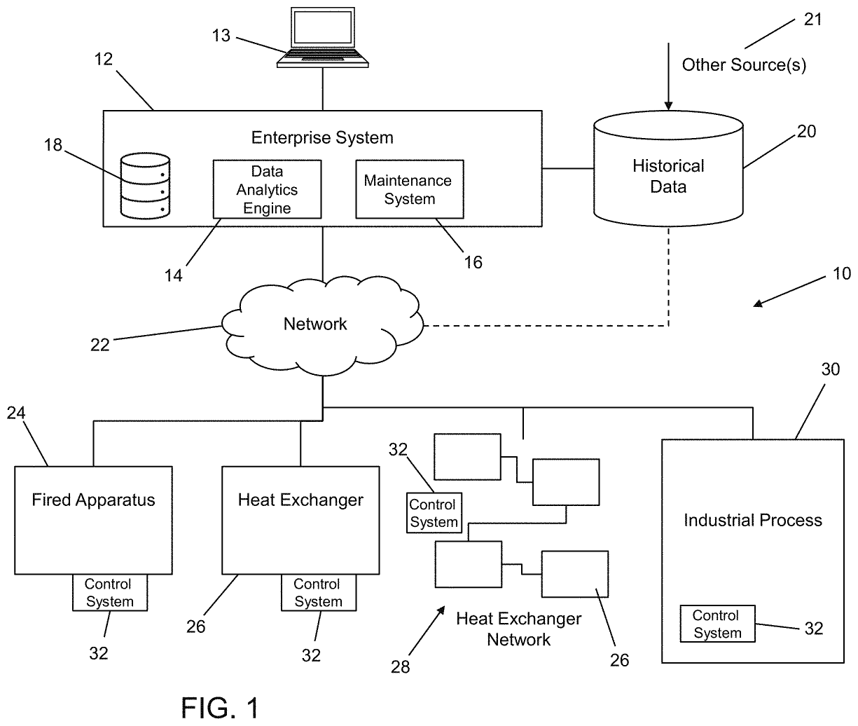

Referring now to the figures, FIG. 1 illustrates a heat exchanger and fired apparatus monitoring and analysis system 10 (hereinafter also referred to as the “system 10”). The system 10 includes an enterprise system 12 representing any computing platform and networked infrastructure used by an organization (e.g., via a computer 13 or computing station as shown) to monitor, communicate with and, optionally, automatically control equipment in one or more facilities. The enterprise system 12 includes at least one server 18 configured to connect to one or more electronic networks 22, a data analytics engine 14, and a maintenance system 16 that can be used by maintenance personnel and/or administrators to schedule and deploy maintenance equipment, personnel, and any materials required to perform a maintenance operation associated with certain equipment, systems, plants, or facilities. For example, the maintenance system 16 can be instructed to clean equipment according to the desired cleaning schedule(s) determined using the system 10. The enterprise system 12 also includes or has access to a database or datastore for storing and consuming historical data 20.

The network 22 shown in FIG. 1 is an electronic network 22 such as a wired and/or a wireless communication system, for example, an existing enterprise communication infrastructure or purpose built network for the system 10. The electronic network 22 can include a communications network such as a telephone network, cellular, and/or data communication network to connect different types of communication devices. For example, the network 22 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The electronic network 22 in this example configuration provides connectivity with and/or into various sites, when to personnel or computing devices at such sites, or by being connected to instruments or computing devices within the sites. In this example, the network 22 provides connectivity into/with a fired apparatus 24, a heat exchanger 26, a heat exchanger network 28, and an industrial process 30 that can include one or more of a fired apparatus 24, heat exchanger 26, and heat exchanger network 28, among other equipment and infrastructure. It can be appreciated that the fired apparatus 24, heat exchanger 26, heat exchanger network 28, and industrial process 30 are shown for illustrative purposes only to demonstrate potential connectivity of the system 10 and the system 10 can be configured to be connected to any one or more of these sites in any configuration that suits a particular application. For example, the enterprise system 12 can be connected to multiple industrial processes 30 at multiple sites within an organization.

As illustrated in FIG. 1, each of the fired apparatus 24, heat exchanger 26, heat exchanger network 28, and industrial process 30 can include one or more control systems 32 integrated into the apparatus or site. For example, the industrial process 30 shown in FIG. 1 can include a single or multiple digital control systems (DCSs) 32 to operate that process 30. Such control systems 32 can be integrated with operational inputs or control parameters of the equipment. The control systems 32 can also be configured to be integrated with measurement instruments or sensors to gather data to be added to the historical data 20. As shown in FIG. 1, the historical data 20 can be populated using both data gathered at each site as well as from other sources 21, such as data historians, third party sources of ambient conditions (e.g., ambient temperature), meta data (e.g., mapping of tags to model variables), economic data (e.g., maintenance costs) etc. As shown using a dashed line, the historical data 20 can optionally be accessible via the network 22 directly or may require access via the enterprise system 12.

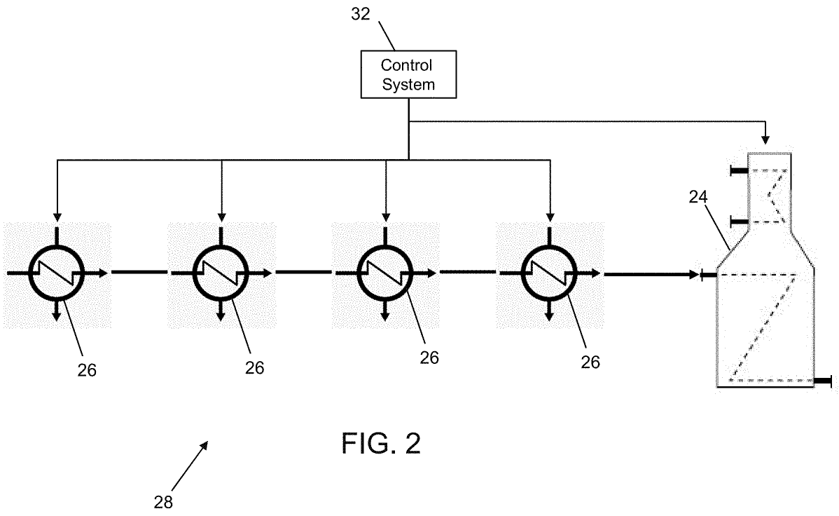

FIG. 2 conceptually illustrates an example of a site or industrial process 30, which includes a heat exchanger network 28 that has a series of heat exchangers 26 which is used to pre-heat a fluid to be heated by a fired heater 24. For example, the heat exchanger network 28 can be used to pre-heat crude oil in a “pre-heat train” that is then further heated to an outlet temperature specification in the fired heater in a crude oil refinery. The heat exchanger network could also be used to pre-heat feedwater for a steam generating apparatus, e.g., for a utility or oil extraction process.

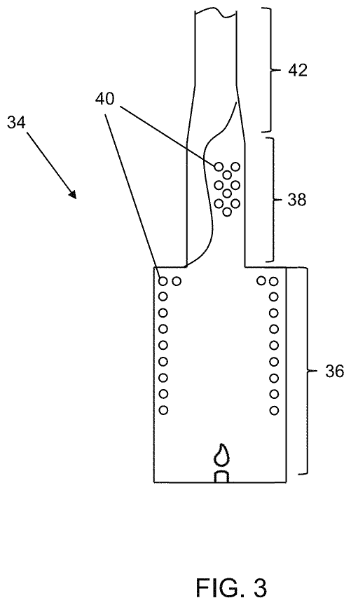

To illustrate the proposed system and method for an example of a fired apparatus, FIG. 3 provides a schematic diagram of a fired apparatus 34. The fired apparatus 34 shown in

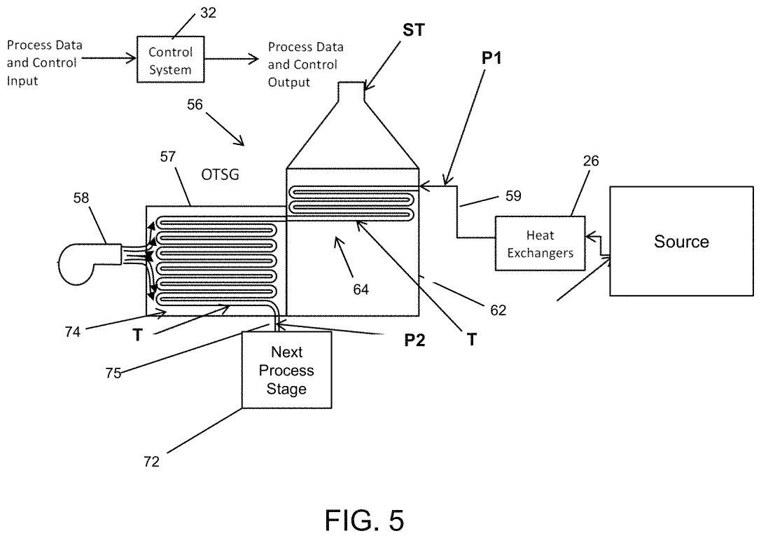

FIG. 3 is indicative of a general heater used in a refinery and includes a radiant section 36, a convection section 38, and a stack 42. The convection and radiant sections include a number of tubes 40 through which a fluid passes. The heater may also include additional economizer sections to recover additional heat into either the process fluid or another fluid (e.g. stream). The configuration shown in FIG. 3 is for illustrative purposes and the principles discussed herein can also be applied to other types of fired apparatus. For example, an OTSG-type steam generating apparatus 56 is shown in FIG. 5 and described below.

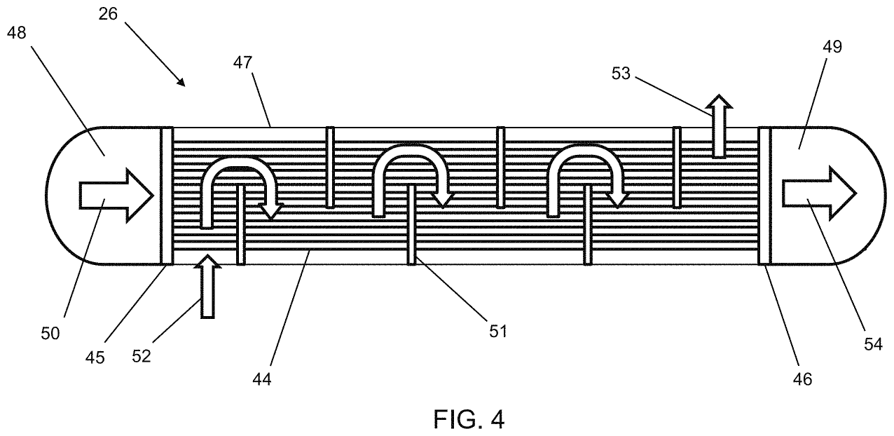

Referring now to FIG. 4, a schematic example of a heat exchanger 26 is shown. FIG. 4 illustrates a shell and tube heat exchanger 26 that includes a set of tubes 44 extending between stationary tubesheets 45, 46. The first tubesheet 45 is positioned at an inlet side of the heat exchanger 26 and the second tubesheet 46 is positioned at the outlet side of the heat exchanger 26. The tubes 44 and tubesheets 45, 46, also referred to herein as a “tube and tubesheet assembly”, are surrounded by a shell 47 that hermetically seals a volume surrounding the tubes 44. Inlet and outlet bonnets 48, 49 or “heads” are coupled to each end of the shell 47 to enable the ingress and egress of a fluid 50 such as a gas to/from the heat exchanger 26.

In the example configuration shown in FIG. 4, the shell 47 includes a series of baffles 51 to direct flow through the shell side in a winding or zigzag pattern. In operation, a fluid such as water is injected into an inlet port 52 and flows through the shell 47 around the tubes 44 towards an outlet port 53. This fluid that surrounds the tubes 44 cools the fluid (e.g., hot gas) that flows through the tubes 44 from the inlet bonnet 48 to the outlet bonnet 49 and exits as a cooled fluid 54 as is known in the art.

Referring now to FIG. 5, an OSTG-type steam generating apparatus 56 includes a radiant section 57 and an economizer 62 (also sometimes referred to as a convection section). The OTSG 56 in the configuration shown in FIG. 5 receives a source fluid 59 at an inlet in the economizer unit 62, which passes through an economizer tubing circuit 64, where the source fluid 59 is heated and possibly partially vapourized by convective heat transfer, or a combination of convective and radiative heat transfer in the portion of the economizer that receives heat from the radiative section.

The tubing circuit 64 in this example includes multiple parallel tubing lengths with return U-bends at one or both ends as illustrated in FIG. 5. The tubing components of the tubing circuit 64 have metal walls with an interior surface that can be in contact with the source fluid 59, and an exterior surface through which a heat flux from a heat source 58 can communicate to heat the source fluid 59 traveling through the tubing circuit 64.

More specifically, the tubing circuit 64 in this example directs the partially heated source fluid 59 to an inlet of the radiant heat unit 57 where the partially heated source fluid 59 is directed through a radiant tubing circuit 74. The radiant tubing circuit 74 is subjected to radiant heat transfer from a heat flux generated by the heat source 58 (e.g., a burner).

The enthalpy of the source fluid 59 increases as the source fluid 59 (e.g. crude, boiler feed water (BFW), etc.) passes through the economizer 62 and then the radiant heat section 57. Heated fluid 75 is directed through outlet tubing to a downstream processing stage 72.

The provision of a source fluid 59 to the fired heater 34, 56 (e.g., OTSG in FIG. 5) and the application of heat from the heat source 58 are commonly controlled by a control system 32 to modify the source fluid throughput and heat that is applied by the heat source 58. With steam generating apparatuses, such as OTSGs 56, and other heated or “fired” apparatuses 24, 34, tube fouling is a problem that occurs due to the accumulation and formation of unwanted materials on the inner surfaces of the tubing in the fired apparatus. This accumulation typically occurs due to coking in the case of coker or crude heaters, or impurities in the feed water in the case of steam generation systems.

As indicated above, historical data 20 can be collected from instruments and other sources, with respect to indicators of fouling, to enable tube fouling predictions to be made. In FIG. 5, “T” denotes exemplary locations at which tube skin temperature measurements can be made, when tube skin temperature is used as the indicator of fouling. The identifiers “P1” and “P2” denote exemplary reference locations for which to measure a pressure drop across the fired apparatus 24, 34, 56. In this example, P1 corresponds to the pressure of the source fluid 59 at the inlet, and P2 corresponds to the pressure of the heated output 75 from the fired apparatus 24, 35, 56, with P1-P2 providing the pressure drop value. The identifier “ST” in FIG. 5 denotes an exemplary location at which to measure the stack temperature of the fired apparatus 24, 34, 56.

It can be appreciated that the measurement locations identified in FIG. 5 are for illustrative purposes only, and measurements of a particular indicator of fouling can be made elsewhere. For example, various other portions of the fired apparatus tubing 40, 64, 74, can be targeted. For example, the crossover between the economizer unit 62 and the radiant heat section 57 of the fired apparatus 24, 34, 56 can be used to measure pressure drop. Also, tube temperatures can be measured anywhere along the tube, and those illustrated in FIG. 5 represent common points of fouling in OTSGs 56. The measurements can be made using available measurement equipment such as thermocouples or thermistors (for temperature), and pressure gauges or digital sensors (for pressure). These measurements can be collected using individual and isolated data acquisition apparatus or using integrated and/or networked devices that communicate with a central server 18 or data storage device such as that storing the historical data 20 as shown in FIG. 1. As such, wired or wireless enabled devices can be used to minimize the physical collection of data stored at devices located throughout the facility. That is, the measurement collection can be performed using any number of data collection techniques.

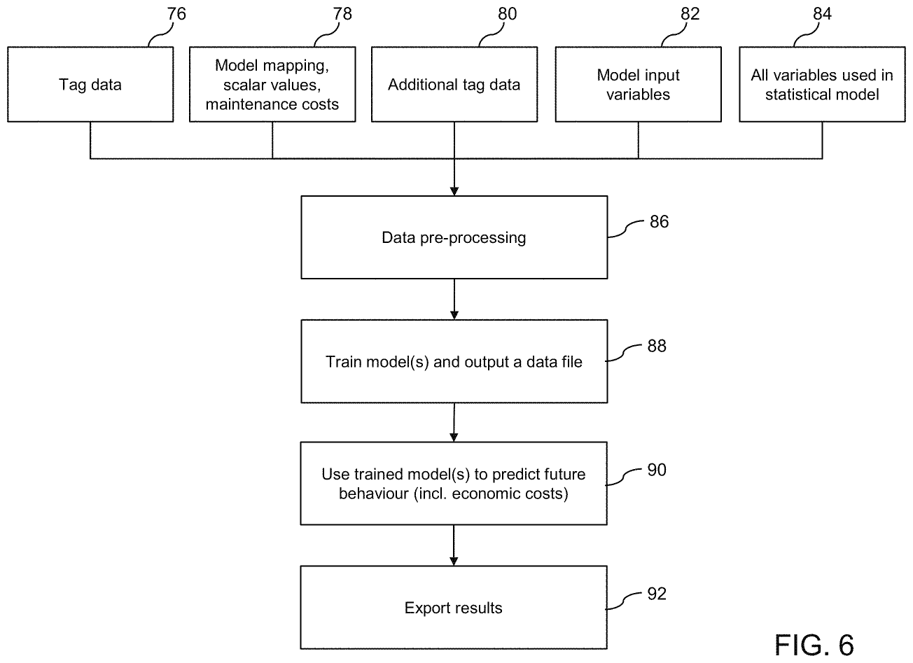

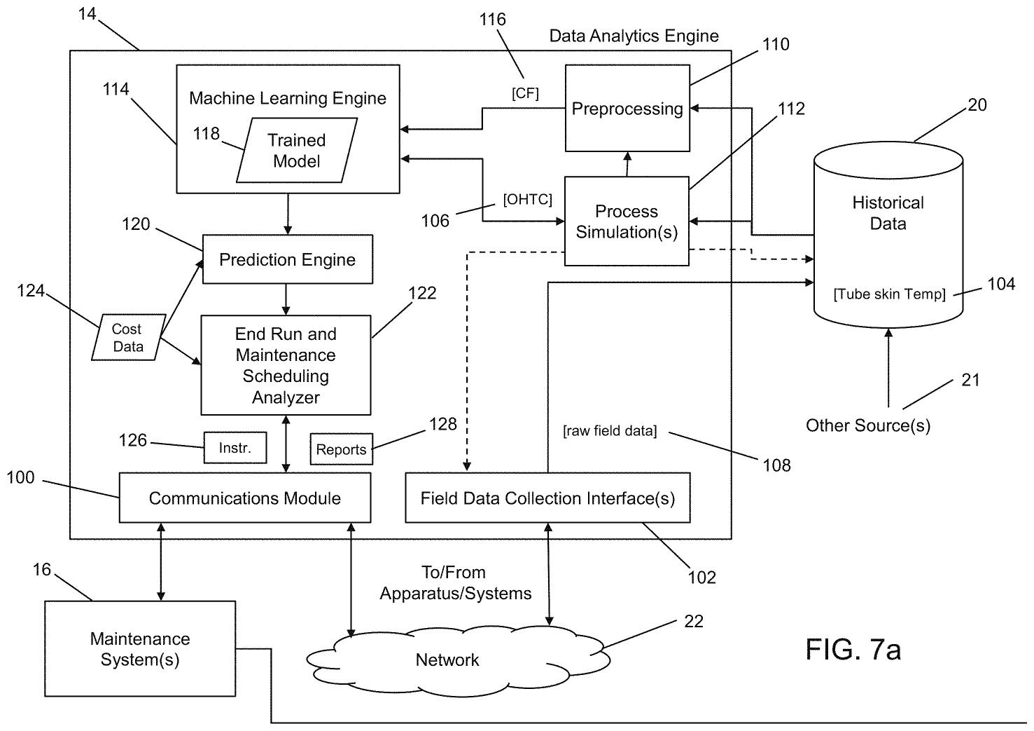

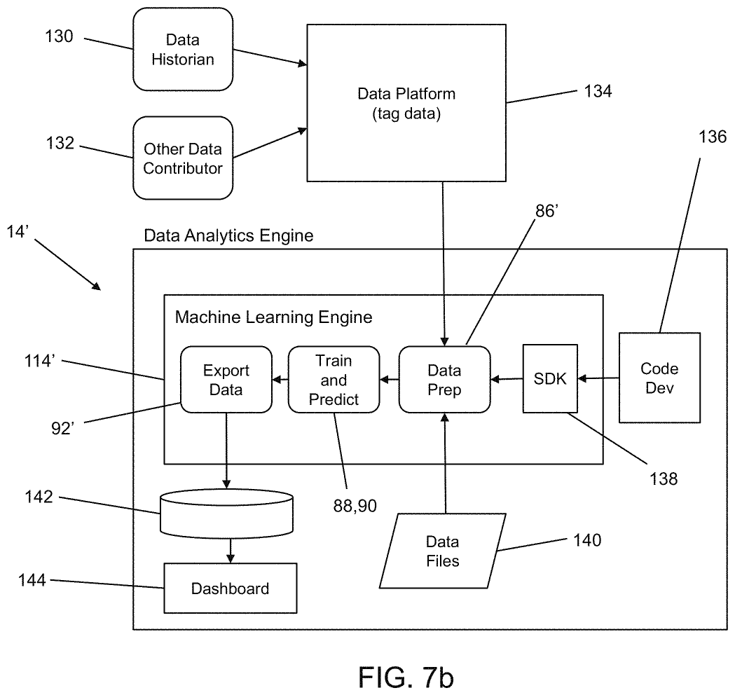

FIG. 6 illustrates a model pipeline to represent an independently executable workflow of a complete machine learning task used by the data analytics engine 14. In the pipeline illustrated in FIG. 6, a number of data sources are collected and processed in a data pre-processing stage 86. For example, tag data 76 is collected, which can include sensor data and process simulator outputs. Map data 78 can also be collected, which includes model mapping, scalar values, and maintenance costs. Additional tag data 80 can also be collected as shown in FIG. 6. Model input variables 82 are also obtained, e.g., duty, cumulative flow, etc. The overall variable set 84 is also obtained, which identifies all variables used in the statistical model, e.g., temperature, flows, OHTC (from simulator), etc. These data sources are processed at the data pre-processing stage 86, which feeds a model training stage 88. The model training stage 88 executes a machine learning engine 114 (see FIG. 7a) to train one or more models and generate an output, e.g., by saving to memory or outputting a data file for each model. A prediction stage 90 can then be executed to use the trained model(s) fitted in stage 88 to predict future behaviour. It can be appreciated that economic factors such as fouling costs and optimum cleaning times can also be calculated in the prediction stage 90. The results are then exported, e.g., to a database, in an output stage 92. It is possible for the training stage 88 and prediction stage 90 to be executed independently as separate pipelines.

Referring now to FIG. 7a, an example of a configuration for the data analytics engine 14 is shown. The data analytics engine 14 includes a communications module 100 configured to communicate via a direct connection or by way of an indirect connection via the network 22, with the maintenance system 16. The communications module 100 can also be used by the data analytics engine 14 to communicate with entities, systems and devices external to the enterprise system 12 as illustrated in FIG. 1. The data analytics engine 14 also includes one or more field data collection interfaces 102 to enable the data analytics engine 14 to communicate via the network 22 with devices, systems, sensors, and other entities to obtain data from a site, apparatus, control system 32 or other source 21. The field data collection interface(s) 102 are also configured to populate the historical data 20 to be used in determining end of run predictions and optimized cleaning schedules as herein described. In this example, the field data collection interface(s) 102 can collect, receive or otherwise obtain raw field data 108 (e.g., sensor data, instrument data, manual inputs from a plant, apparatus or process, etc.).

The historical data 20 can include other values, such as tube skin temperature values 104. The tub skin temperature values 104 are measured (e.g., as discussed above), and can also be obtained via the network 22 and field data collection interface(s) 102 from the site, process or apparatus.

It can be appreciated that the data analytics engine 14 can be implemented using a client device (e.g., computing device 13 shown in FIG. 1) which includes one or more processors other data storage devices storing device data and application data (not shown), the processor(s) being configured to execute instructions that utilize the modules and components shown in FIG. 7a, including the communications module 100 and field data collection interface(s) 102 by implementing communication protocols utilized by the particular configuration and/or application. That is, while not delineated in FIG. 7a, the data analytics engine 14 includes at least one memory or memory device that can include a tangible and non-transitory computer-readable medium having stored therein computer programs, sets of instructions, code, or data to be executed by a processor. It can be appreciated that any of the modules and applications shown in FIG. 7a may also be hosted externally and be available to the data analytics engine, e.g., via the communications module 100 or field data collection interface(s) 102. The device data, can include, without limitation, an IP address or a MAC address that uniquely identifies client device 13 within the system 10. The application data, can include, without limitation, login credentials, user preferences, cryptographic data (e.g., cryptographic keys), etc.

Other modules not shown in FIG. 7a that can also be utilized by the data analytics engine 14 and/or client device 13 configured to implement same include, without limitation, a display module for rendering GUIs and other visual outputs on a display device such as a display screen, and an input module for processing user or other inputs received at the client device 13, e.g., via a touchscreen, input button, transceiver, microphone, keyboard, etc.; standard or customized applications or “apps”, and a web browser application for accessing Internet-based content, e.g., via a mobile or traditional website.

To utilize the historical data 20 and to perform statistical modelling, the data analytics engine 14 can include various modules as shown in FIG. 7a that are arranged and configured to process and analyze data according to both engineering (i.e., first) principles and using advanced data-driven analytics using machine learning and/or other advanced automation algorithms. In this example, the data analytics engine 14 includes a preprocessing module 110 to prepare, transform, and clean the historical data 20; and a process simulation module 112 to apply the functionality of one or more process simulators to generate inputs for a machine learning engine 114. An example of an output of the processor simulation module 112 is OHTC values 106 that are computed based on other measurements input to the processor simulation module 112. The processor simulator(s) 112 can also include a thermodynamic engine that allows for the calculation of physical properties used in the determination of, among other variables, the OHTC. The machine learning engine 114 uses the preprocessed and/or process simulation data outputs to generate one or more trained models 118 that can be used to perform a prediction using a prediction engine 120 to generate a prediction that can be used by an end of run and maintenance scheduling analyzer 122 (also referred to as the “analyzer 122” for brevity). The analyzer 122 can use a prediction generated by the prediction engine 120 to, for example, schedule a shut down of a fired heater 24 according to a predicted end of run for that fired heater 24 or to plan to take a heat exchanger 26 offline for cleaning. The analyzer 122 can also use a prediction generated by the prediction engine 120 to determine an optimized cleaning schedule for an entire heat exchanger network 28. The prediction engine 120 and/or analyzer 122 can use cost data 124 associated with maintenance costs and costs of running the heat exchanger 26 or network 28 with, for example, a lower OHTC value 106.

The analyzer 122 can generate instructions 126 or reports 128 that can be communicated to a site via the network 22 or can be provided to the maintenance system 16. It can be appreciated that the maintenance system 16 can also be further integrated with the data analytics engine 14, e.g., to include the analyzer 122 or the entirety of the data analytics engine 14 in other configurations. The instructions 126 can include commands for control systems 32 to implement automated changes or can include instructional information for an operator for manual operational changes or to automatically shut down an apparatus. The analyzer 122 can include a cleaning script or other tool that can be automatically deployed to periodically or continuously analyze the predictions generated by the prediction engine 120 to determine when a shutdown should occur.

As illustrated in FIG. 7a, the machine learning engine 114 can be used to not only generate the trained model 118 based on historical data 20 and currently obtained data, but also to feed current data to the prediction engine 120 to generate a current prediction for the analyzer 122. The historical data 20 that is used to train the model 118 can be updated with the most recent data every time that the model 118 runs as illustrated by the pipeline in FIG. 6. That is, the model 118 can be configured to always using an up to date training dataset. After the model 118 is trained and ready for prediction, the engine 14 can specify a condition at which the response variable (e.g. tube skin temperature, or OHTC) is to be predicted. This condition could be the current condition (e.g., using the current flow), or else (e.g., at an increased flowrate).

In the configuration shown in FIG. 7a, the preprocessing module 110 can be configured to compute cumulative flow (CF) 116 as an indicator of the cumulative load on the fired apparatus 24 or heat exchanger 26, i.e., how much has been fed through the apparatus during a cycle. The CF 116 can be used as a proxy for feed quality and the value can be compared to past cycles of that apparatus to determine where in the duty cycle the apparatus currently is. The CF 116 can be used in addition to other parameters, such as O₂ (excess oxygen), air flowrate, air temperature, process duty, inlet temperature. It can be appreciated that by using the engine 14, an operator or engineer can, for example, determine whether an end of run for a fired heater can be extended or if a heat exchanger can be economically cleaned at a particular time. For example, site engineers can see how much they can stretch out a run by manipulating the input parameters, in particular the feed rate.

It can also be appreciated that outcomes from the prediction engine 120, can be used as inputs to the process simulation(s) 112, thereby enabling simulations based on predicted fouling behavior. The outcome from these simulations can be issued as report(s) 128, or/and as additional inputs to the end of run and maintenance scheduling analyzer 122. Information exchanged between these steps could be automated or entered by users.

FIG. 7b illustrates an alternative configuration for implementing the data analytics engine 14′. In this example a data historian 130 and one or more other data contributors 132 are coupled to a data platform 134, which enables the tag data 76 and additional tag data 80 to be collected and fed to the data pre-processing and prep module 86′ of the machine learning engine 114′. The data prep module 86′ can also be accessed by code development services 136 that access the machine learning engine 114′ via a software development kit (SDK) 138 or other interface mechanism. The data prep module 86′ can also be fed one or more data files 140, e.g., to obtain the model mapping, scalar values and maintenance cost data 78 and statistical model variables 84. As illustrated in FIG. 6, the data prep module 86′ feeds the training and prediction modules 88, 90, either serially or in parallel (shown combined for illustrative purposes). The training and prediction modules 88, 90 feed a data export module 92′ that can store the outputs of the training and prediction modules 88, 90 in a database or other data storage device 142. In this example, a dashboard user interface 144 can access the output data stored in the data storage device 142.

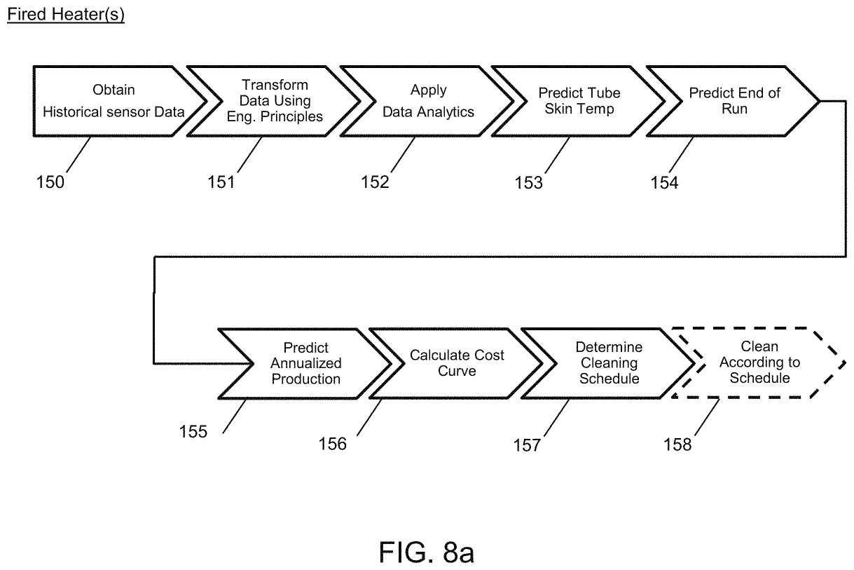

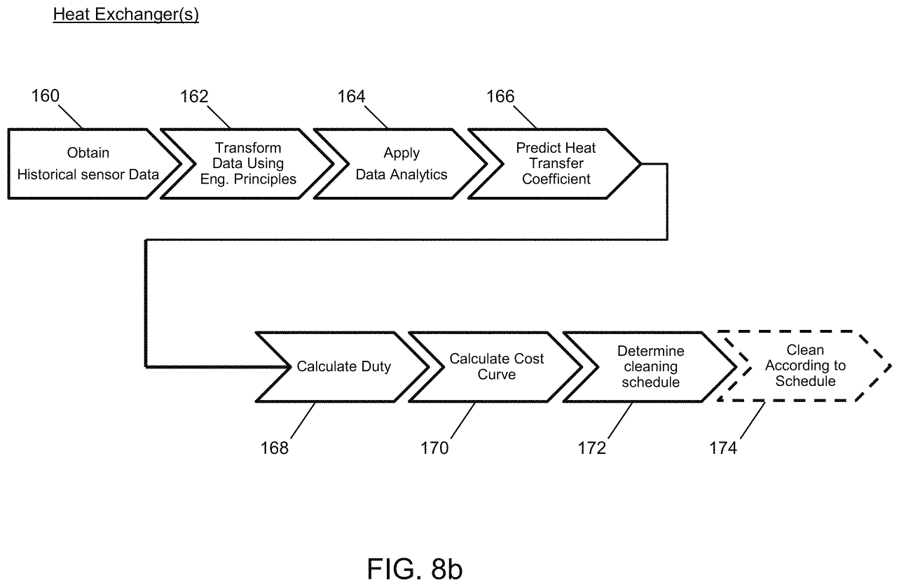

FIG. 8a illustrates computer executable instructions that can be executed in predicting an end of run for a fired heater 24, 34, 56, which can be used further to calculate a cost curve and subsequently schedule shut downs and/or cleaning/maintenance for such a fired heater 24, 34, 56. At 150 historical sensor data 20 is obtained and at 151 this data is transformed using engineering (first) principles using the preprocessing module 110 and, optionally, process simulation(s) 112. The transformed data can then be used to apply data analytics at 152 using the machine learning engine 114 to predict a tube skin temperature 104 into the future at 153 to enable scheduling relative to an upper limit or threshold tube skin temperature 104. This can be used to predict an end of run at 154. Given an end of run 154, one may calculate annualized cumulative production 155 of the cycle and subsequently generate a cost curve 156 which ultimately can be used at 157 to determine a cleaning schedule. The cleaning schedule can, optionally, be used to initiate and/or perform the actual cleaning of the fired heater(s) at 158.

FIG. 8b illustrates computer executable instructions that can be executed in determining an optimum cleaning schedule for a heat exchanger 26 and/or heat exchanger network 28. At 160 historical sensor data 20 is obtained and at 162 this data is transformed using engineering (first) principles using the preprocessing module 110 and process simulation(s) 112. The transformed data can then be used to apply data analytics using the machine learning engine 114 to predict OHTC values 106 into the future at 166. At 168 the predicted OTHC value 106 can be used to calculated duty at that future time, and then at 170 can calculate a cost curve using the calculated duty and other cost data 124. The cost curve calculated at 170 can then be used at 172 to determine an economic optimum cleaning schedule that can be used by the maintenance system 16. The cleaning schedule can, optionally, be used to initiate and/or perform the actual cleaning of the heat exchanger(s) at 174.

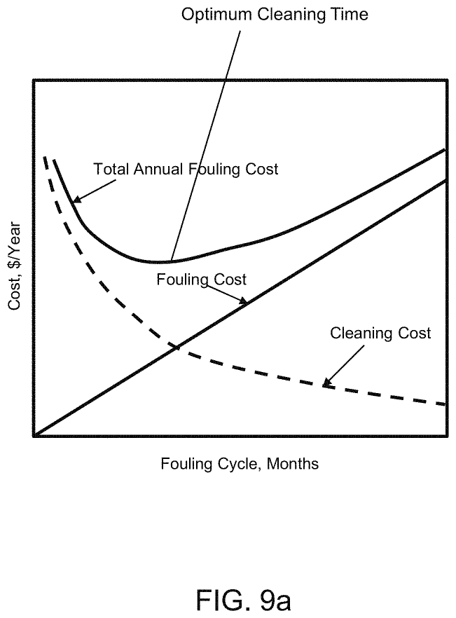

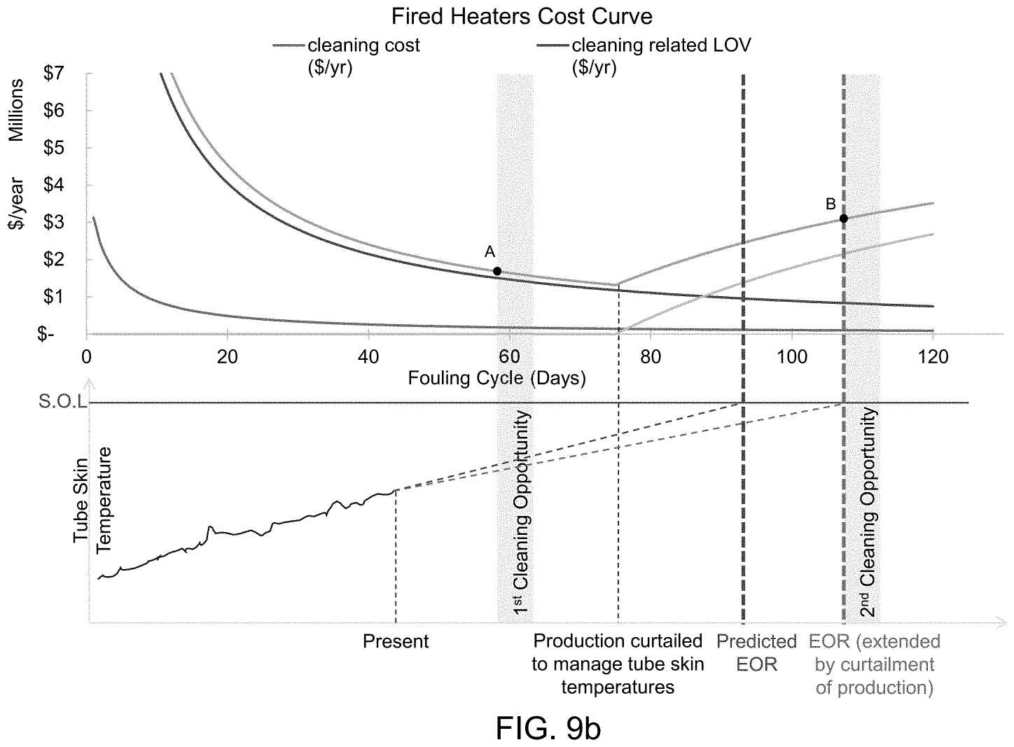

Referring now to FIG. 9a, an example of a cost curve for determining an optimum cleaning time for a heat exchanger is shown. In this example the cost per year is calculated against the fouling cycle. Where the fouling cost curve crosses the cleaning cost curve indicates an optimized economic timing for cleaning a heat exchanger 26. It can be appreciated that similar cost curves can be computed for other heat exchangers 26 in a heat exchanger network 28 and/or industrial process 30 as shown in FIGS. 1 and 2. This optimum cleaning time can provide a basis for determining an economical or desired cleaning time. For example, the information illustrated in FIG. 9a9 can be mapped against plant shut downs or other planned maintenance to coordinate and balance the costs of shutting down versus the increased costs of running a unit.

FIG. 9b is an example of a fired heater cost curve coupled with tube skin temperature 104 curve to illustrate economic assessment of two different cleaning scenarios. Similar to FIG. 9a. the cost per year is calculated against the fouling cycle. To eliminate the impact of run length, costs can be normalized with respect to time, hence annualization. As shown in FIG. 9b, the prediction engine 120 is predicting the end of run to be between two cleaning opportunities. In order to make it to the latter cleaning opportunity, one may lower production rate and extend the run length. However, this comes at the cost of production loss which is balanced by the cost of cleaning. Point B in FIG. 9b represents the total cost for such scenario. Alternatively, the fired apparatus can be cleaned (or pigged) at the former cleaning opportunity with no impact on production and a total cost of what shown as point A. By comparing A against B, one can determine a desired cleaning schedule for a fired heater.

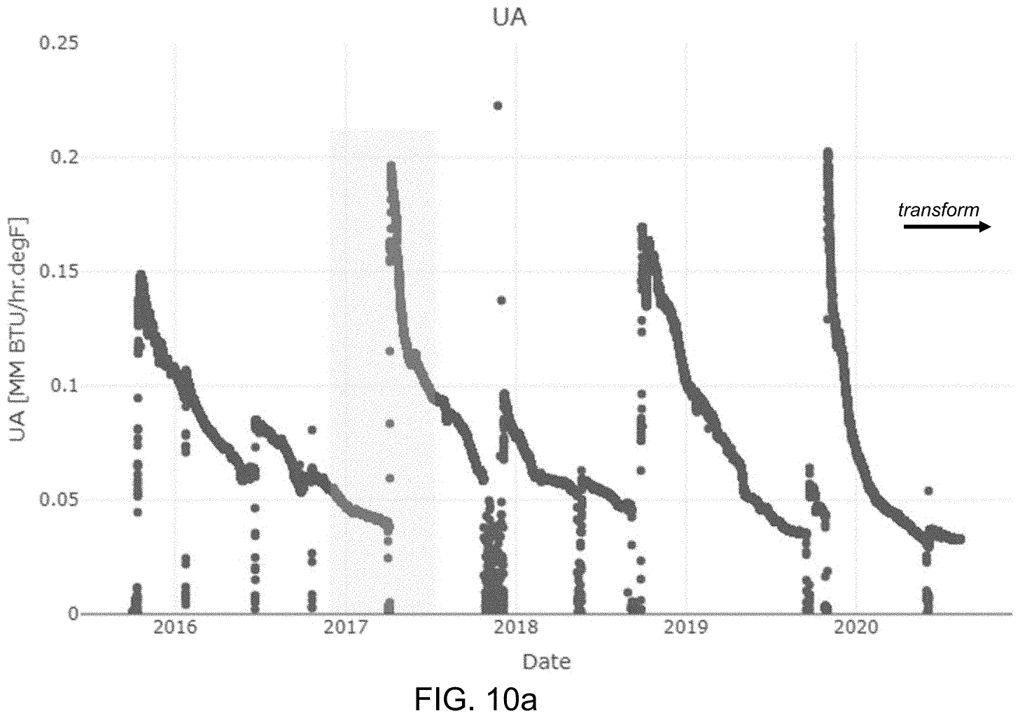

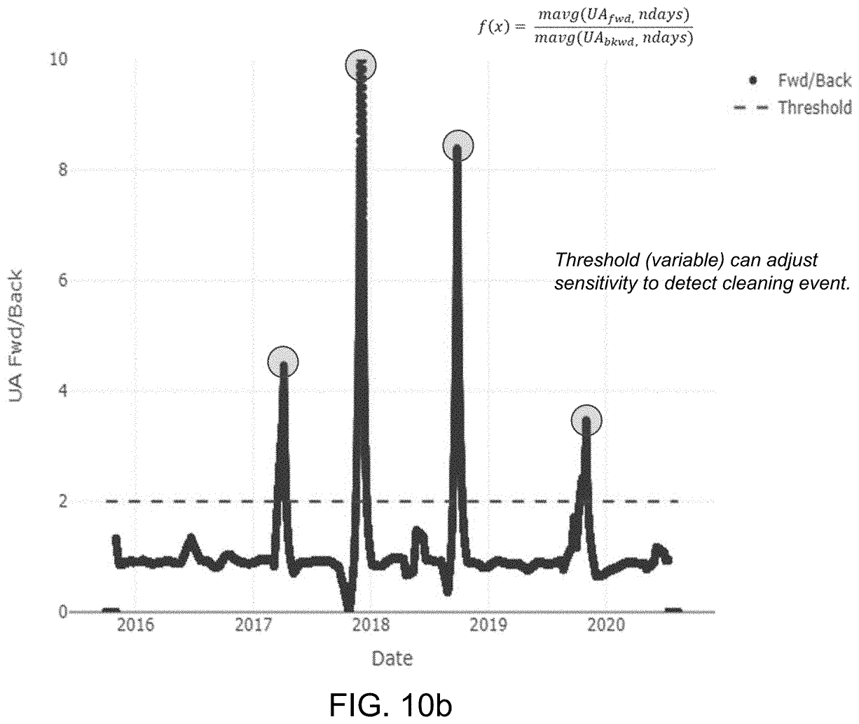

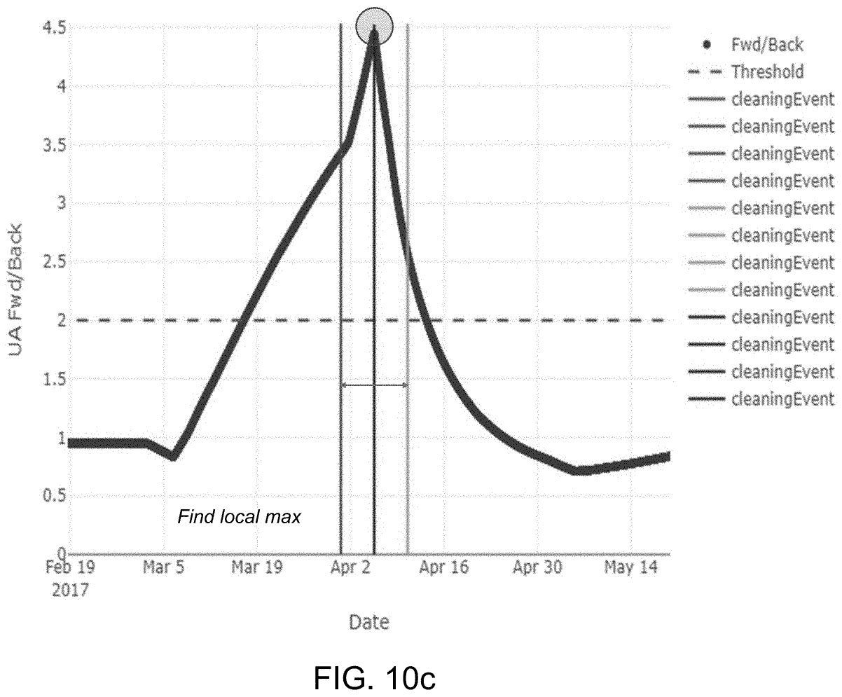

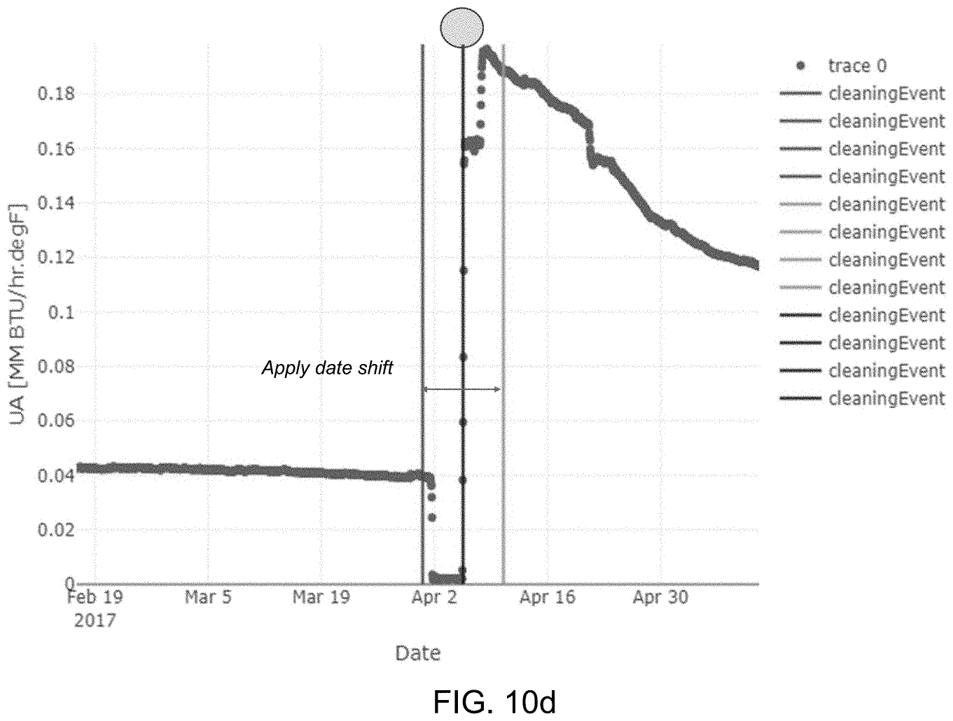

FIGS. 10a, 10b, 10c, and 10d illustrate a cleaning detection using a data transformation. The respective variable to which cleaning detection is applied e.g., OHTC 106, tubeskin temperature etc. (FIG. 10a) is transformed to a ratio of the forward and backwards moving averages of this variable which will be referred to as “f” (FIG. 10b). The number of days (or points) used in the respective moving average can be independently set. The next step is to assess whether “f” exceeds a specified threshold that can be adjusted based on sensitivity requirements. To avoid clusters of points with similar dates, the local maximum is selected within a specified cluster size (FIG. 10c). Cycle end and start dates are subsequently determined either by applying a fixed date offset from the local maximum or using further calculations (FIG. 10d).

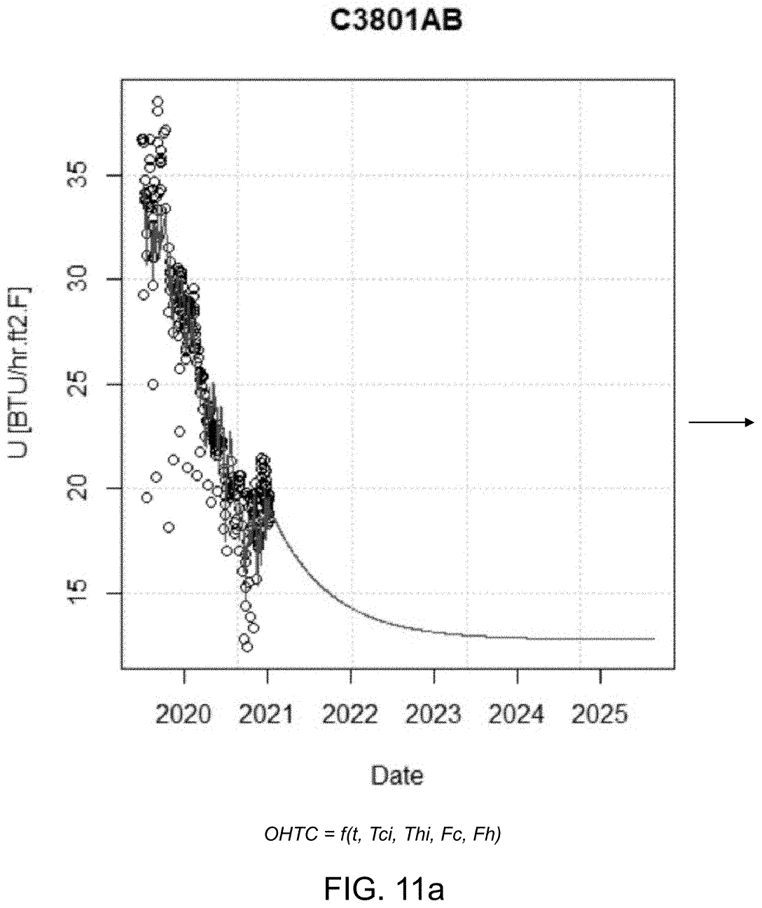

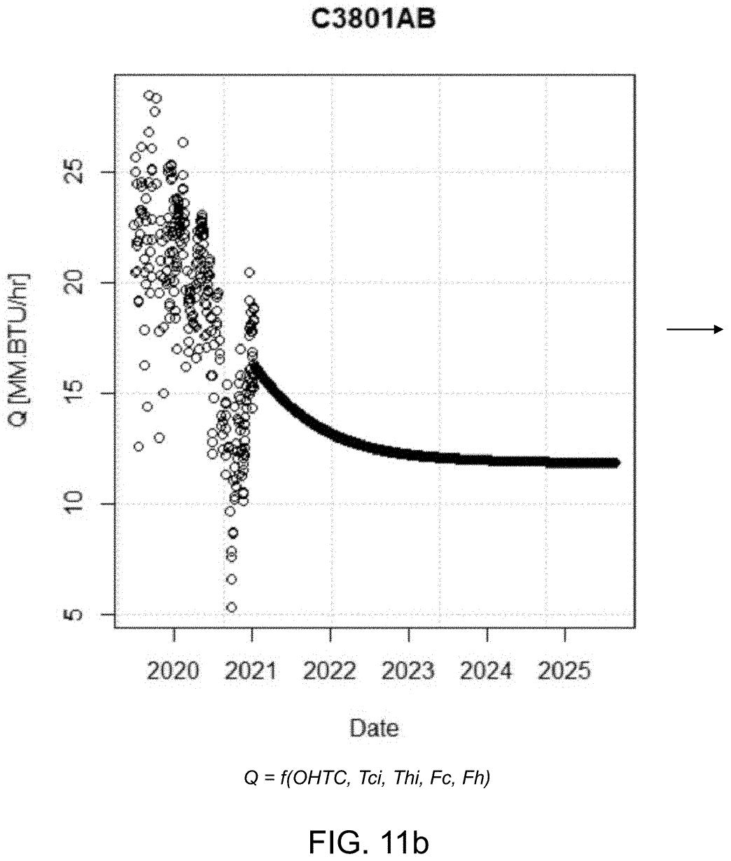

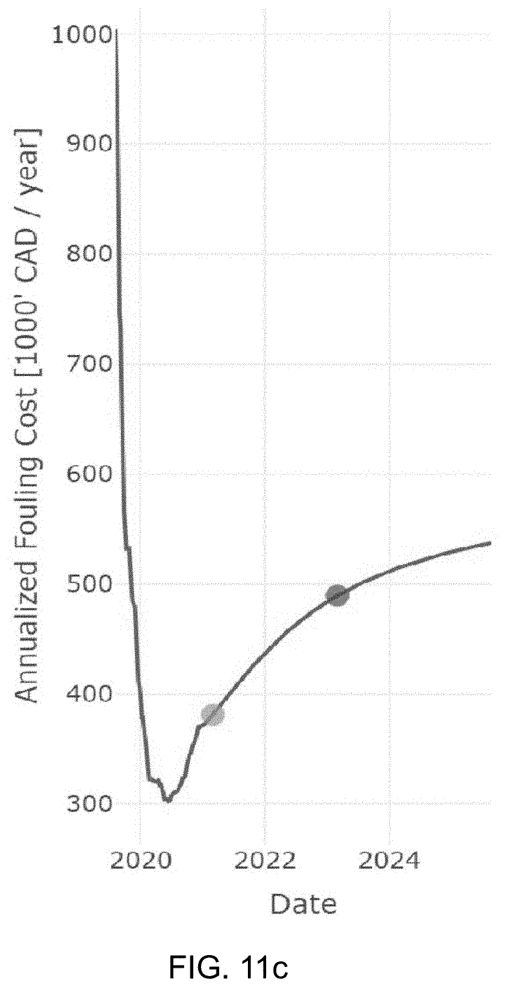

FIGS. 11a, 11b, and 11c illustrate an annualized fouling cost computed from an OHTC 106 prediction and a heat duty (Q) calculation. The heat duty Q (FIG. 11b) is calculated based on mass and energy balances using the model predicted OHTC 106, inlet hot side and cold side temperatures (Tci and Thi), respective cold side and hot side flowrates (Fc and Fh) and other physical properties (e.g., heat capacities and densities for the respective streams). The annualized fouling cost (FIG. 11c) is then calculated by adding the respective fouling cost, based on fuel gas required to compensate for decreasing duty (FIG. 11b), annualized maintenance cost based on historic costing information, and CO₂ taxes based on the equivalent CO₂ release rate of the fuel gas (based on fuel gas composition). The trade off between the decreasing annualized maintenance cost (due to the increasing cycle length) and the fouling and CO₂ tax results in a minimum which can be considered the optimum cleaning time. This curve can subsequently be used to assess the economic cleaning costs of two different cleaning dates (shown as dots on curve in FIG. 11c).

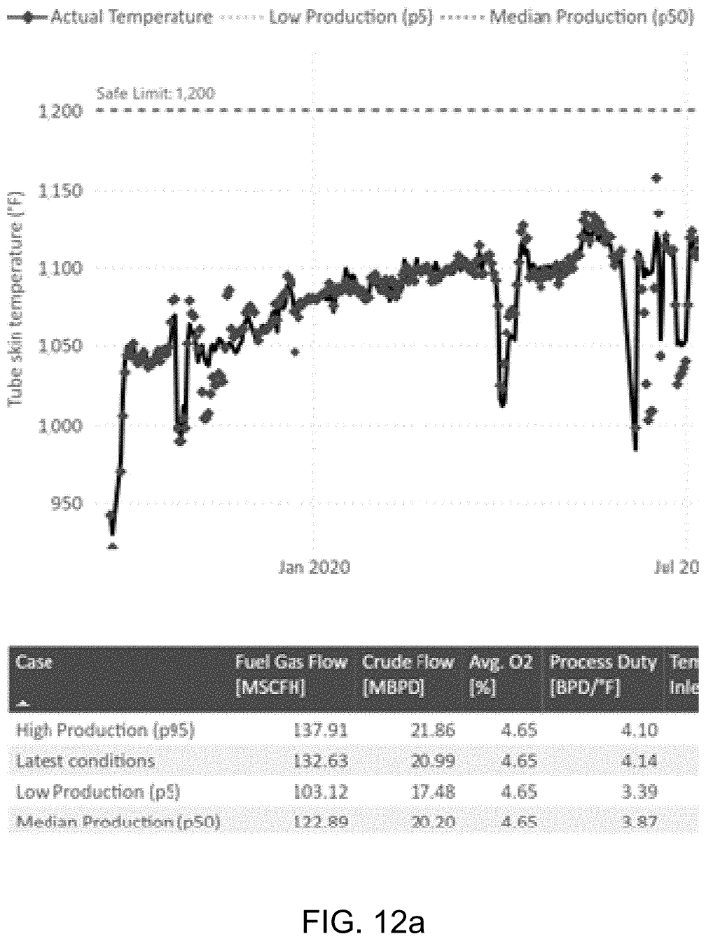

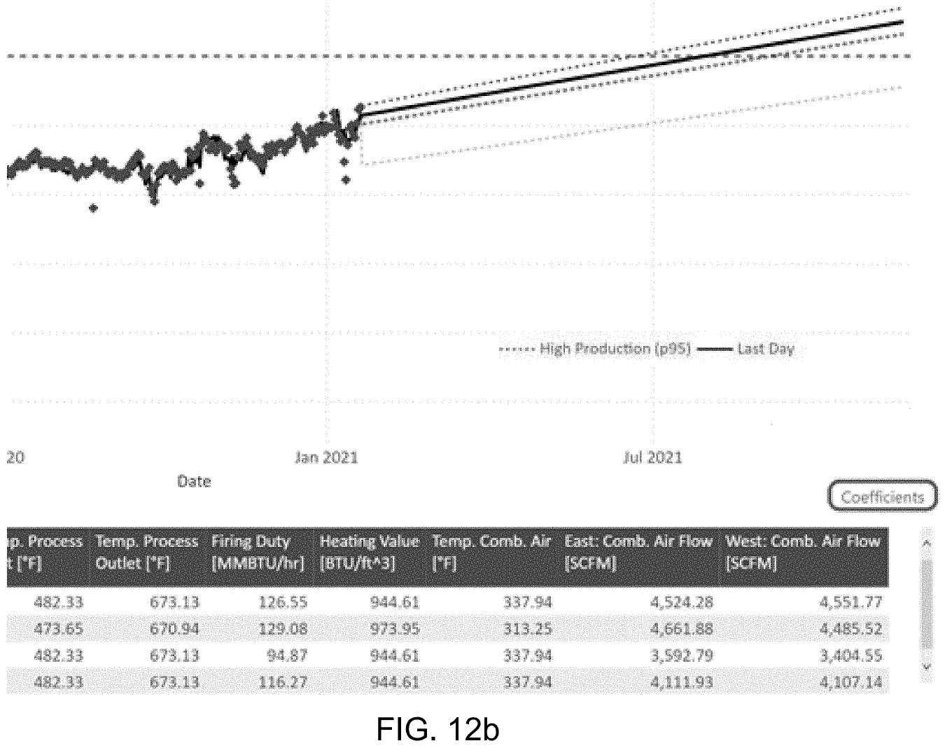

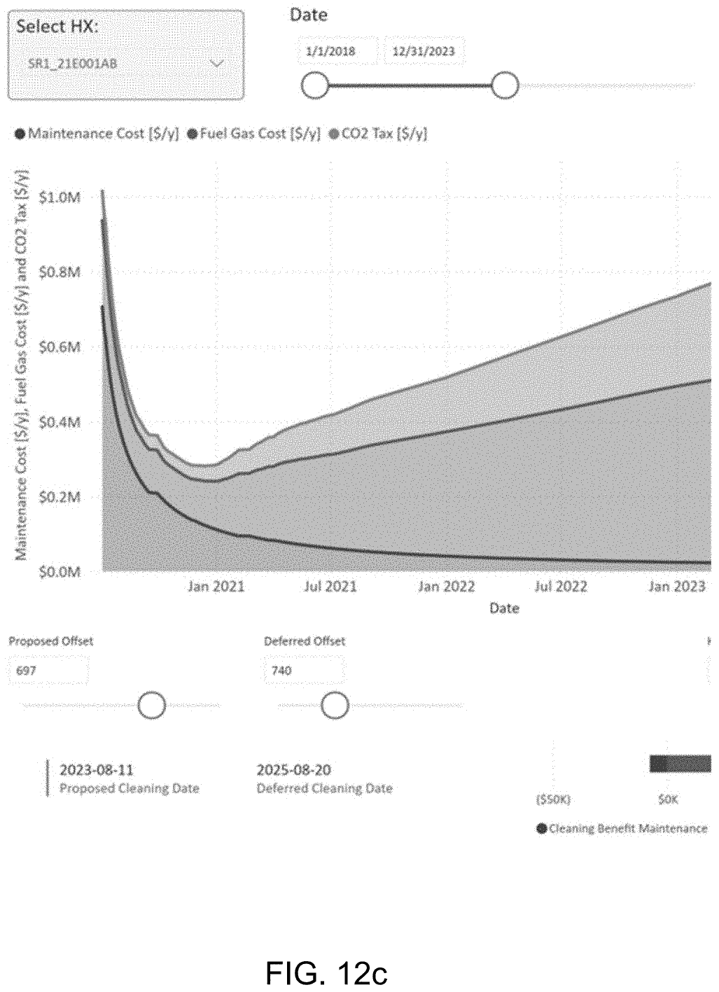

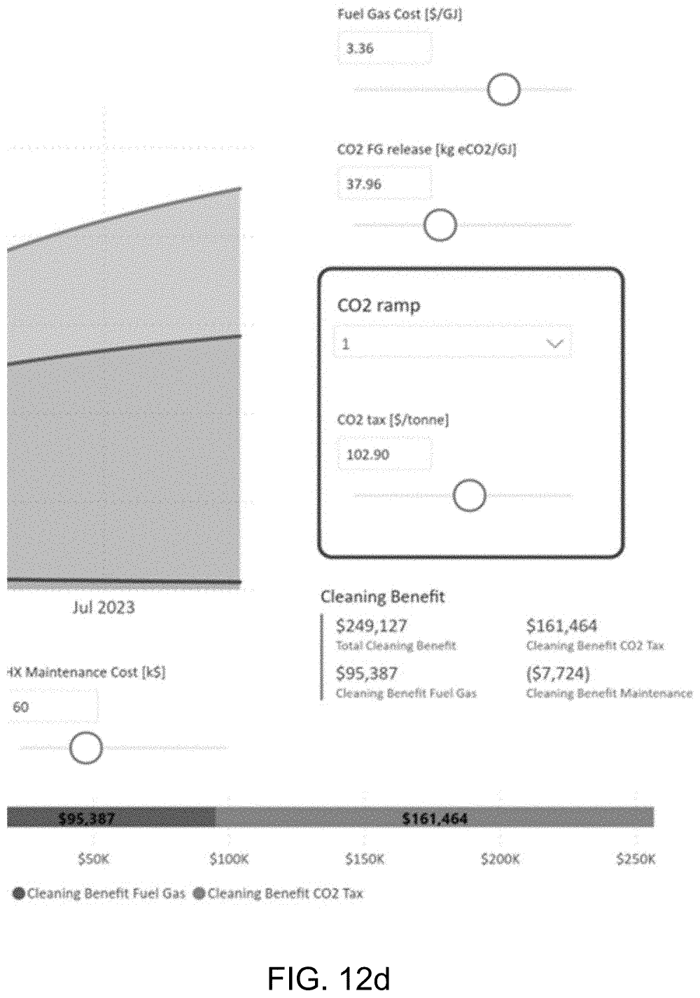

FIGS. 12a and 12b show a tube skin temperature prediction graph provided in a graphical user interface. The graph enables one to predict when the safe operating limit will be reached for each tube skin temperature thermocouple and in this example uses an elastic-net regression technique to arrive at a robust model that avoids overfitting. It can be appreciated that other types of statistical modelling techniques can be employed. The illustrated model is a generalized linear model but contains non-linear terms. For example, the heat exchanger models contain an exponential term to capture the asymptotic behavior of the heat transfer coefficient. This is first separately fitted using a non-linear equation solver. Predictions can be made for different scenarios (e.g., low, median, high and current production conditions).The model re-training and updates are automated and deployed to a site contact or control system 32, e.g., via a dashboard configured to display the user interface. The graph depicts the model prediction for different scenarios (or model inputs). In the graph (FIG. 12a) this is shown for low (5^{th} percentile), median (50^{th} percentile), high (95^{th} percentile) and current production (50^{th} percentile for last day) conditions. The model can also be evaluated for a custom set of input conditions.

FIGS. 12c and 12d show the heat exchanger cost curve using an interactive graphical user interface. Different inputs to the cost data can be adjusted by the user to see the impact on the cost curve. The user can select different proposed and deferred cleaning dates and the dashboard will show the corresponding cleaning benefit.

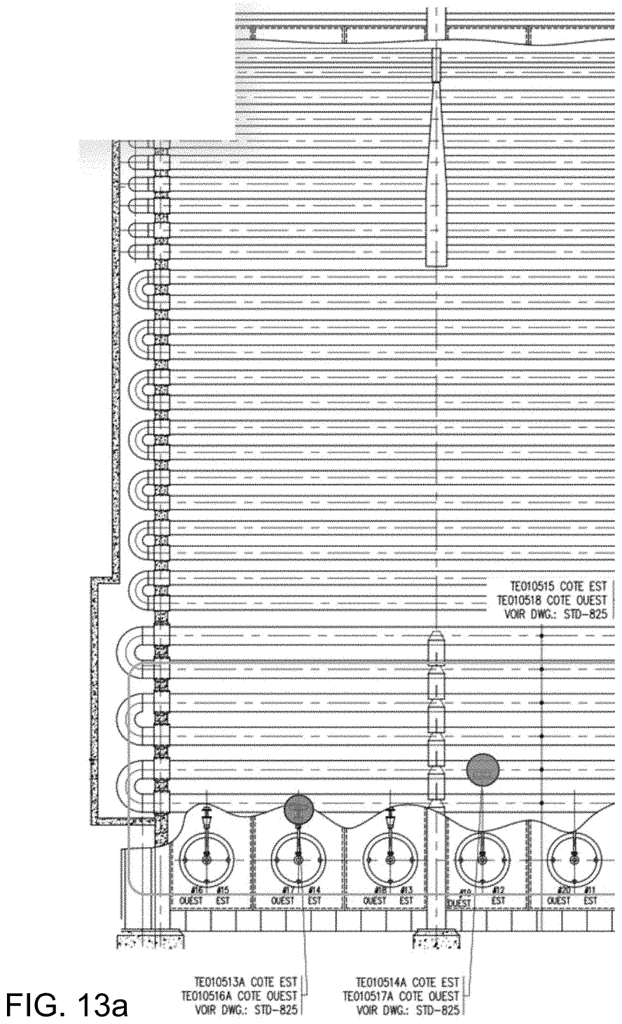

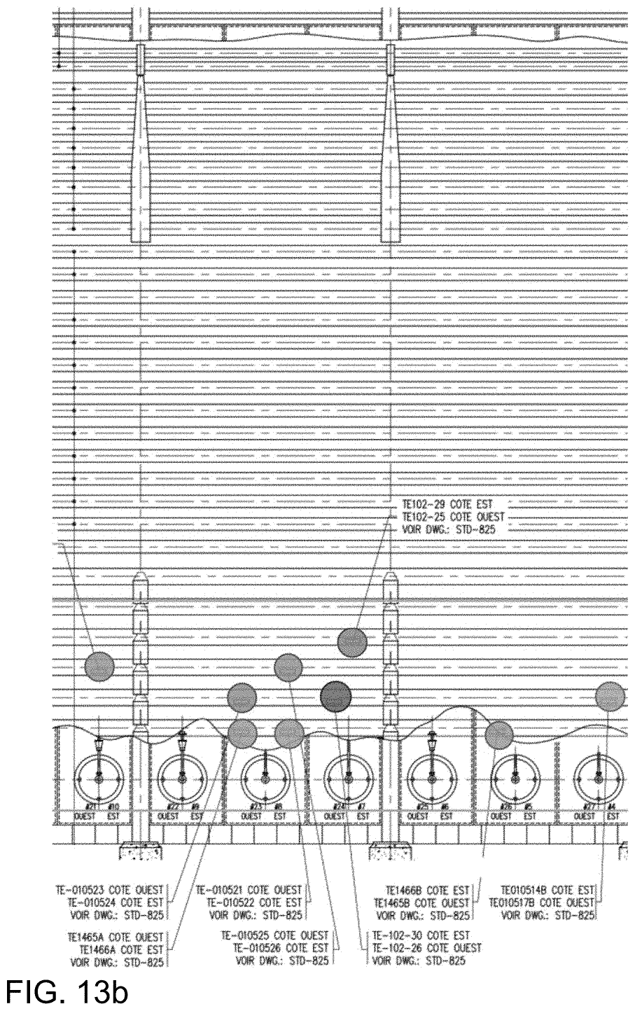

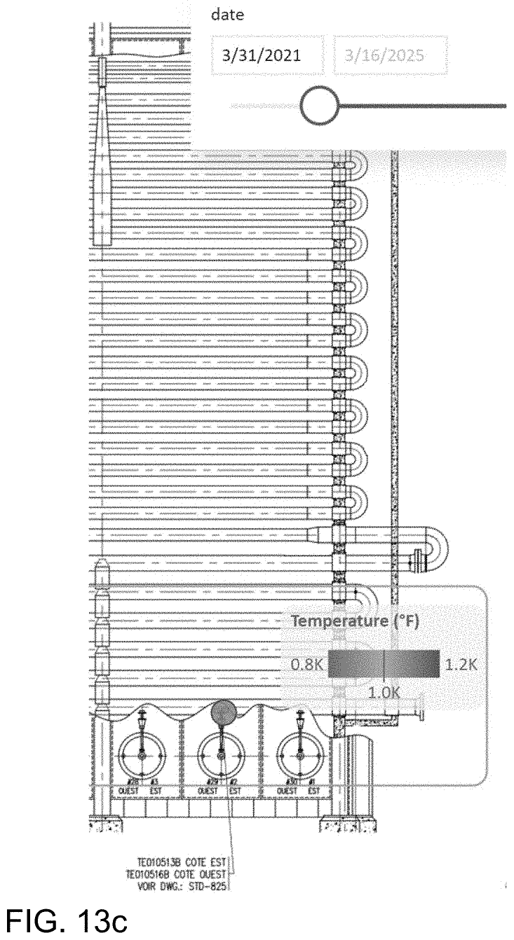

FIGS. 13a, 13b, and 13c are a spatial depiction of a tube skin monitoring system showing a thermocouples map in a fired heater 24, 34, 56 provided in a graphical user interface. This allows the user to see the evolution of temperature changes over time and visibly differentiates areas of higher temperatures and outliers based on the color of the circles.

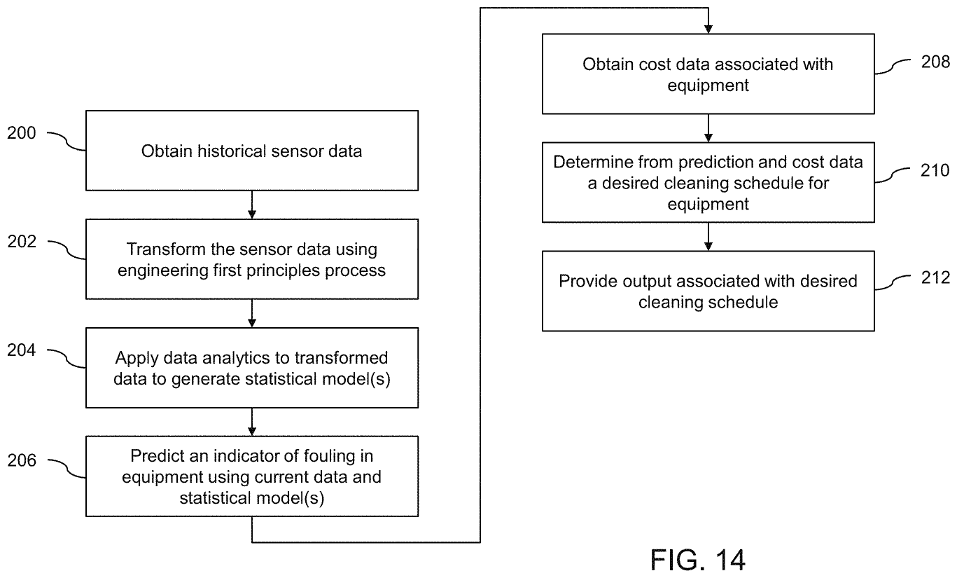

FIG. 14 is a flow chart illustrating operations that can be performed in determining cleaning schedules for equipment, including fired heaters and/or heat exchangers. At 200 the system 10 obtains historical data, which can be done manually, over the network 22, or a combination of both. At 202, the sensor data is transformed using at least one engineering first principles process as discussed above. This enables the system 10 to apply data analytics at 204 (e.g., using the machine learning engine 114) to the transformed data to generate at least one statistical model for making predictions with respect to the equipment being analyzed. As illustrated above, this can include one or more heat exchangers, a fired apparatus, and/or a plant or operation that includes a combination of such equipment. At 206, the system 10 uses the data analytics engine 14, 14′ to predict an indicator of fouling in the equipment, using current data and the at least one statistical model. The system 10 also obtains cost data at 208, which is associated with operating the equipment and can include costs associated with running the equipment at a less than optimum output, e.g., to prolong a run to accommodate a planned shut down to schedule a cleaning more economically. At 210, the system 10 determines from the prediction and the cost data a desired cleaning schedule for the equipment and, at 212, provides an output associated with this desired cleaning schedule, e.g., an instruction, report, control signal, etc.

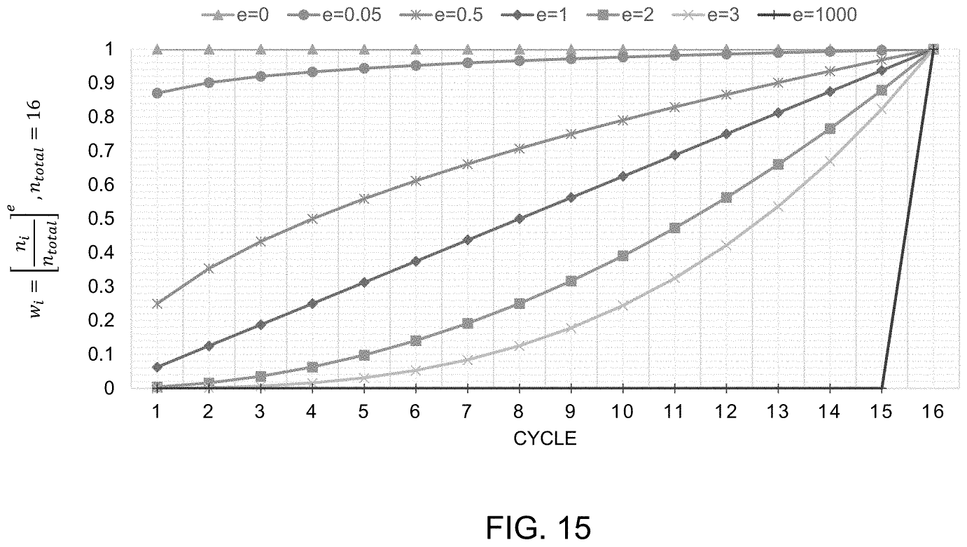

FIG. 15 is a plot that shows the impact of the cycle weighting strategy. For this example 16 cycles are considered; however, this can be applied to any number of cycles. In the equation “i” refers to the cycle number corresponding to “wᵢ”. Depending on the exponent “e”, the weighting on historical cycles can be adjusted. In the case of e=0, all the cycles are equally weighted. In the case of a large number e.g. e=1000, the historical cycles have almost no contribution and only the current cycle is considered. Practically this number can be adjusted based on the model performance requirements and expectations with the aim being to give a higher weight to more recent cycles.

For simplicity and clarity of illustration, where considered appropriate, reference numerals may be repeated among the figures to indicate corresponding or analogous elements. In addition, numerous specific details are set forth to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the enterprise system 12, computing device 13, apparatuses 24, 26, 28, 30, network 22, data analytics engine 14, maintenance system 16 control system 32, or any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of determining cleaning schedules for equipment comprising fired heaters and/or heat exchangers, comprising:
obtaining historical sensor data;
transforming the obtained sensor data using an engineering first principles process;
applying data analytics to the transformed data to generate at least one statistical model;
predicting an indicator of fouling in the equipment using operating data and the at least one statistical model;
obtaining cost data associated with the equipment being analyzed;
determining from the prediction and cost data a desired cleaning schedule for the equipment; and
providing an output associated with the desired cleaning schedule.

2. The method of claim 1, wherein the desired cleaning schedule is determined as an economic optimum by comparing an optimum cleaning time to at least one external factor.

3. The method of claim 2, wherein the at least one external factor comprises scheduled shut down or maintenance events for the equipment, the desired cleaning schedule being determined according to a comparison of costs associated with running the equipment past the optimum cleaning time with costs associated with adding a shut down event to accommodate the desired cleaning.

4. The method of claim 2, wherein the desired cleaning schedule is selected as the optimum cleaning time.

5. The method of claim 1, wherein the equipment comprises at least one heat exchanger and wherein determining the desired cleaning schedule comprises predicting an overall heat transfer coefficient as the indicator of fouling, calculating a duty value of the heat exchanger, and calculating a cost curve associated with operating the heat exchanger.

6. The method of claim 5, wherein the duty value comprises a cumulative value.

7. The method of claim 6, wherein the duty value comprises cumulative flow.

8. The method of claim 6, wherein the duty value comprises cumulative impurities.

9. The method of claim 1, wherein the equipment comprises at least one fired heater and wherein determining the optimum cleaning schedule comprises predicting a tube skin temperature as the indicator of fouling, predicting an end-of-run for the fired heater based on the predicted tube skin temperature, and calculating cumulative production at the end of run date to calculate a cost curve.

10. The method of claim 1, wherein the equipment comprises a heat exchanger train comprising a plurality of heat exchangers and a fired heater.

11. The method of claim 1, wherein the data analytics comprises applying at least one machine learning technique to train the at least one statistical model.

12. The method of claim 11, further comprising re-training the at least one statistical model using data accumulated since the model was previously trained.

13. The method of claim 11, wherein at least one first statistical model is trained for heat exchangers, and/or at least one second statistical model is trained for fired heaters.

14. The method of claim 1, further comprising:
determining at least one cleaning detection variable;
transforming the at least one cleaning detection variable to a ratio of forward and backwards moving averages of the respective variable;
setting a number of points representing a number of days used in the respective moving average;
determining whether the transformed ratio exceeds a specified threshold, the threshold being adjustable based on at least one sensitivity requirement;
selecting a local maximum within a cluster of the points; and
using the local maximum in determining the desired cleaning schedule.

15. The method of claim 14, wherein the desired cleaning schedule is determined by comparing the local maximum to a fouled state.

16. The method of claim 1, further comprising:
identifying cycles of the equipment;
fitting a combination of historical cycles; and
using a weighting strategy to apply a higher weight to more recent cycles than older cycles to prioritize fitting more recent data.

17. The method of claim 5, further comprising determining an annualized fouling cost from an overall heat transfer coefficient as the indicator of fouling, by:
determining a heat duty based on mass and energy balances using a predicted overall heat transfer coefficient, inlet hot and cold side temperatures, respective inlet hot and cold side flowrates, and at least one additional physical property; and
adding respective fouling costs based on fuel gas required to compensate for decreasing duty, annualized maintenance cost based on historic cost data, and emission-related costs based on a release rate of the fuel gas.

18. The method of claim 17, wherein a tradeoff in the desired cleaning schedule is determined between decreasing annualized maintenance cost and fouling and emission-related costs, wherein a minimum is selected as an optimum cleaning time.

19. The method of claim 1, further comprising:
coupling a fired heater cost curve with a tube skin temperature curve to calculate a cost per year against a fouling cycle;
normalizing costs with respect to time; and
predicting an end of run for at least one cleaning opportunity.

20. The method of claim 19, wherein the end of run is predicted for a plurality of cleaning opportunities and the method further comprises enabling a comparison and a selection to be made between the plurality of cleaning opportunities.

21. The method of claim 1, wherein the output comprises a graphical user interface dashboard.

22. The method of claim 1, wherein the output comprises control instructions for operating the equipment.

23. The method of claim 1, further comprising continually collecting raw field data.

24. The method of claim 1, wherein a fouling status is compared to a clean state for the equipment.

25. A computer readable medium comprising computer executable instructions for determining cleaning schedules for equipment comprising fired heaters and/or heat exchangers, the computer executable instructions comprising instructions for:
obtaining historical sensor data;
transforming the obtained sensor data using an engineering first principles process;
applying data analytics to the transformed data to generate at least one statistical model;
predicting an indicator of fouling in the equipment using operating data and the at least one statistical model;
obtaining cost data associated with the equipment being analyzed;
determining from the prediction and cost data a desired cleaning schedule for the equipment; and
providing an output associated with the desired cleaning schedule.

26. A system for determining cleaning schedules for equipment comprising fired heaters and/or heat exchangers, the system comprising a processor and memory, the memory storing computer executable instructions that, when executed by the processor, cause the system to:
obtain historical sensor data;
transform the obtained sensor data using an engineering first principles process;
apply data analytics to the transformed data to generate at least one statistical model;
predict an indicator of fouling in the equipment using operating data and the at least one statistical model;
obtain cost data associated with the equipment being analyzed;
determine from the prediction and cost data a desired cleaning schedule for the equipment; and
provide an output associated with the desired cleaning schedule.

27. A method of detecting cleaning schedules for equipment comprising fired heaters and/or heat exchangers, comprising:
determining at least one cleaning detection variable;
transforming the at least one cleaning detection variable to a ratio of forward and backwards moving averages of the respective variable;
setting a number of points representing a number of days used in the respective moving average;
determining whether the transformed ratio exceeds a specified threshold, the threshold being adjustable based on at least one sensitivity requirement;
selecting a local maximum within a cluster of the points; and
using the local maximum in determining the desired cleaning schedule.
